(19) United States
(12) Patent Application Publication
(10) Pub. No.: US 2013/0061231 A1
(43) Pub. Date: Mar. 7, 2013

(54) CONFIGURABLE COMPUTING ARCHITECTURE

(71) Applicants: Dong-Qing Zhang, Plainsboro, NJ (US); Rajan Laxman Joshi, San Diego, CA (US)

(72) Inventors: Dong-Qing Zhang, Plainsboro, NJ (US); Rajan Laxman Joshi, San Diego, CA (US)

(21) Appl. No.: 13/697,085

(22) PCT Filed: May 11, 2010
(86) PCT No.: PCT/US10/01390

§ 371 Date: Nov. 9, 2012

(51) Int. Cl. G06F 9/46

(52) U.S. Cl. 718/102

(57) ABSTRACT

A configurable computing system for parallel processing of software applications includes an environment abstraction layer (EAL) for abstracting low-level functions to the software applications; a space layer including a distributed data structure; and a kernel layer including a job scheduler for executing parallel processing programs constructing the software applications according to a configurable mode.

### TECHNICAL FIELD

The invention generally relates to parallel processing computing frameworks.

### BACKGROUND OF THE INVENTION

In order to accelerate the execution of software applications, parallel processing frameworks have been developed. Such frameworks are designed to run on high-performance computing (HPC) platforms including, for example, multi-core computers, single-core computers, or computer clusters.

The paradigm of developing software applications to run on HPC platforms is different from programming applications to run on a single processor. In the related art some programming models have been suggested to facilitate the development of such applications. For example, MapReduce of Google is a general parallel processing framework, which has been pervasively used to develop many Google applications, such as the Google search engine, Google map, BigFile system, and so on. The MapReduce programming model provides software developers with an application layer for developing parallel processing software. Thus, developers should not be aware of characteristics of the physical infrastructure of the computing platform. MapReduce is implemented in a C++ programming language and is designed to run on Google's clustered application servers.

Another example is the Hadoop provided by Yahoo® which is a distributed computing library based on the MapReduce architecture and written in the Java programming language. The MapReduce and Hadoop provide an abstract layer for high-level software applications to access the low level parallel processing infrastructures.

OpenMP is an example for a programming model that offers developers a simple and flexible interface for developing parallel software applications for computing platforms ranging from desktops to supercomputers. However, The OpenMP supports only multi-core computers with a shared-memory architecture.

As can be understood from the above discussion each of the programming modes for developing parallel software applications is designed for a specific HPC platform. This is a limiting factor as applications cannot be developed and deployed in different HPC or non-HPC platforms. Therefore, it would be advantageous to provide a solution that would cure the deficiencies introduced above.

### SUMMARY OF THE INVENTION

Certain embodiments of the invention include a configurable computing system for parallel processing of software applications. The computing system comprises an environment abstraction layer (EAL) for abstracting low-level functions to the software applications; a space layer including a distributed data structure; and a kernel layer including a job scheduler for executing parallel processing programs constructing the software applications according to a configurable mode.

Certain embodiments of the invention also include a method for executing a software application including at least one parallel processing program over a high-performance computing (HPC) platform. The method comprises reading a configuration file designating a configurable mode of operation of the HPC platform; saving input data required for execution of the parallel processing program in a space layer; running instances of the parallel processing program according to the configurable mode of operation; and saving output data generated by instances in the space layer.

### BRIEF DESCRIPTION OF THE DRAWINGS

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

FIG. 1 is a block diagram of a configurable computing system constructed in accordance with an embodiment of the invention.

FIG. 2 is a diagram of an inheritance tree implemented in the kernel layer.

FIG. 3 is a flowchart describing the operation of a job scheduler implemented in accordance with an embodiment of the invention.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

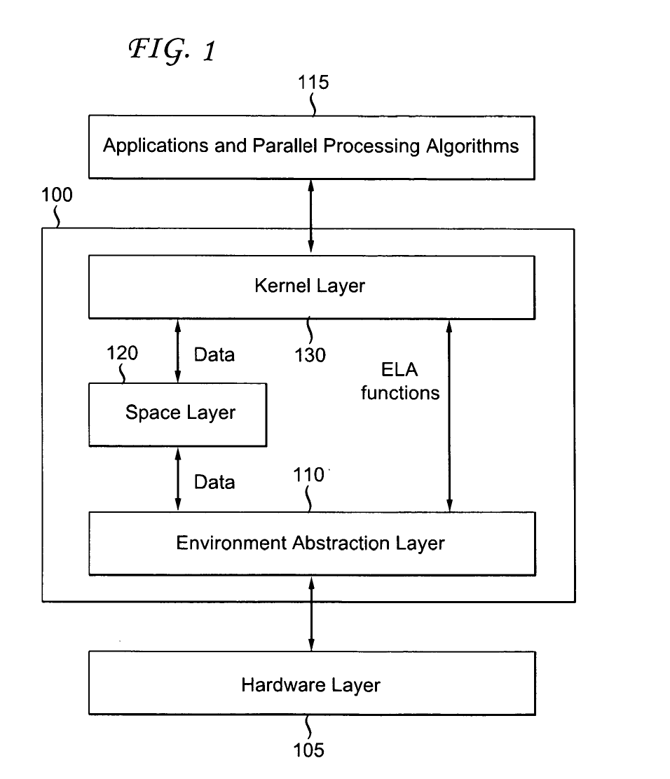

FIG. 1 shows an exemplary and non-limiting block diagram of a configurable computing system 100 constructed in accordance with an embodiment of the invention. The computing system 100 is a computing architecture that can be configured to allow parallel processing of software applications on different HPC platforms without the need of modifying and recompiling the application's source code. The term computing architecture refers to the structure and organization of a computer's hardware and software. HPC platforms include, but are not limited to, multi-core computers, single-core computers, and computer clusters.

The computing system 100 comprises an environment abstraction layer (EAL) 110, a space layer 120, and a kernel layer 130. The EAL 110 abstracts low-level functions, such as hardware (represented as a hardware layer 105) and operating system functions to software applications 115 executed over the computing system 100. The hardware layer 105 includes, for example, a computer cluster, one or more personal computers (PCs) connected in a network, or one or more multi-core computers. Examples for functions abstracted by the EAL 110 are communication and scheduling functions.

The space layer 120 consists of a distributed data structure that is shared and can be accessed by different computers in a network. For a distributed computing system, all inputs and outputs can be stored in the space layer 120. Whenever a program executed on one of the computers in the network needs input data, the program can send a request to the space layer 120 to retrieve the input data. Output data generated by the program can be saved in the space layer 120.

The space layer 120 can be local or remote to an executed software application. If the space layer is local, the data is directly retrieved or saved in a local memory of a computer executing the application. If the space layer 120 is remote, i.e., not located at the same computer as the application, the space layer 120 automatically forwards the data through a network to the computer where a memory is allocated for the space layer's 120 data structure. It should be apparent to one of ordinary skill in the art that the advantages of using space-based system is that the software applications do not need to know the specific location of the memory for saving and retrieving data. This is due to the fact that the system 100 automatically handles the communication of data if a remote data transfer is needed. Thus, this advantageously simplifies the process of developing software applications.

The kernel layer 130 provides the software applications 115 with the parallelization design patterns for different parallelization granularities. The software applications 115 implement parallel processing programs (or algorithms) in order to fully utilize the advantages of HPC platforms. An example for a software application 115 is a video player, which is considered as a resource consuming application. The parallelization granularities for video processing applications include, for example, frame-based parallelization, slice-based parallelization, and so on.

In accordance with an embodiment of the invention, the parallelization design patterns of the kernel layer 130 are implemented as a list of base classes. Base classes are utilized in object oriented programming languages, such as Java and C++.

The computing system 100 allows implementing a parallel processing program as an application class inherited from the parallelization design patterns (or base classes). Parallel processing programs can be executed independently on different computers or different cores (i.e., processors). Thus, each computer or core runs an instance of the parallel processing program (or an instance of the application class).

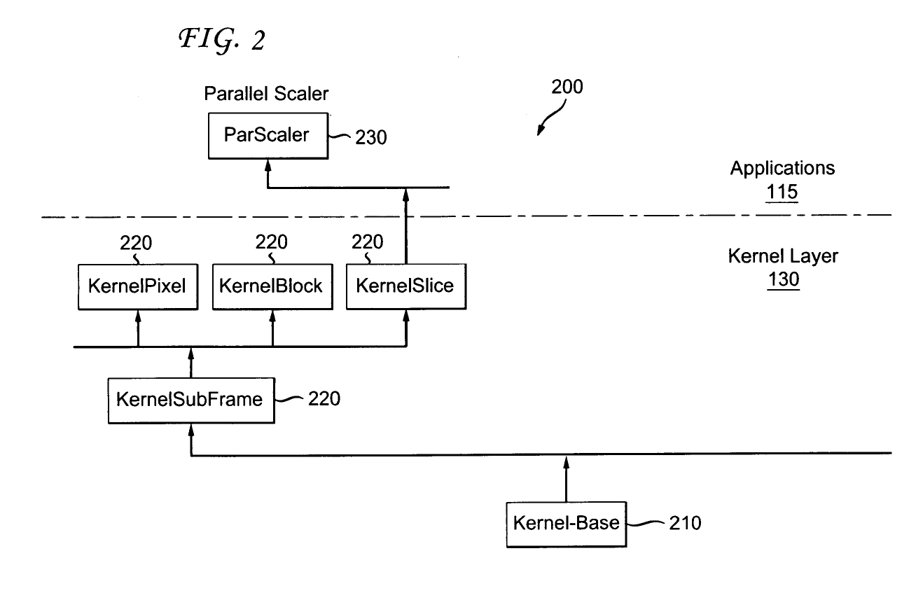

For example, FIG. 2 shows an inheritance tree 200 designed for a parallel scaler program which is a parallel processing algorithm utilized in image processing. The root of the inheritance tree 200 is a kernel-base program (or class) 210 and the nodes are parallelization design patterns 220 (or basic classes) that can be inherited by the parallel scaler program 230. In this example, the parallel scaler program 230 inherits a “KernelSlice” to implement a parallel scaling algorithm. The kernel-base program (or class) 210 implements a number of basic and common functionalities shared by the inherited parallelization design patterns 220.

Typically, the kernel-base program 210 and parallelization design patterns 220 are provided by the kernel layer 130 and part of the computing system 100. The parallel processing programs (e.g., parallel scaler 230) are created by the program developers based on one of the parallelization design patterns. The process for developing parallel processing programs that can be efficiently executed by the computing system 100 is provided below.

The kernel layer 130 also implements a job scheduler, not shown, but known to those skilled in the art, for executing the parallel processing programs, based on a mode of operation defined for the computing system 100. When executed, the parallel processing program retrieves and saves data from and to the space layer 120 and communicates with the operating system and hardware components using functions of the EAL 110.

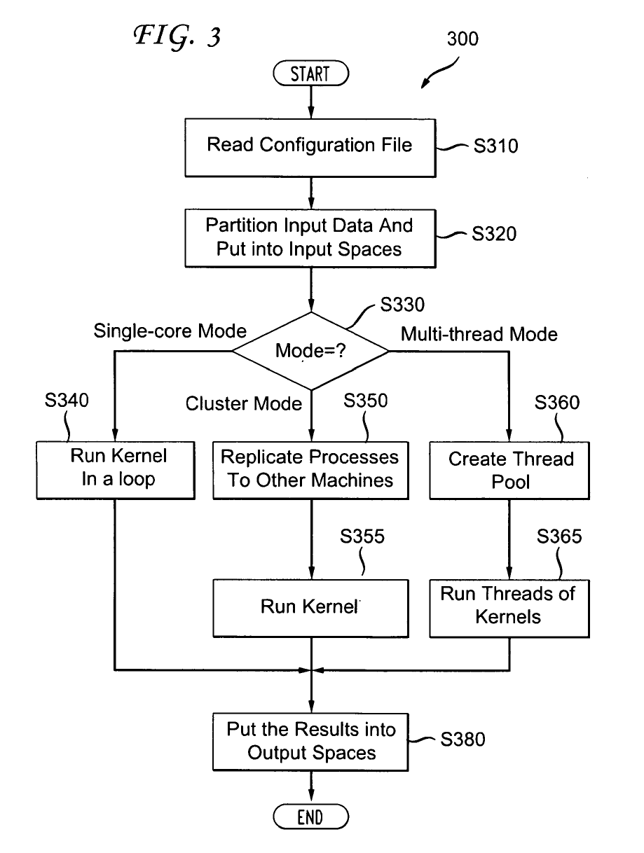

FIG. 3 shows an exemplary and non-limiting flowchart 300 describing the operation of the job scheduler as implemented in accordance with an embodiment of the invention. At S310 a configuration file is read to determine the mode of operation of the computing system 100. The system 100 includes a software framework that supports at least three modes: a single-core mode, a multi-thread mode, and a cluster mode. That is, the developer configures the mode of operation, through the configuration system, based on the type of the platform that application should be executed over.

At S320 input data required for the execution of a parallel processing program is partitioned into data chunks and saved into the space layer 120. As mentioned above, the space layer 120 can be located in the same computer as the job scheduler or in a different computer. At S330, execution of the method is directed according to run instances of the parallel processing program according to the designated configurable mode.

Specifically, execution reaches S340 when the mode is a single-core. In this mode the job scheduler creates a predefined number of instances of the parallel processing program, and then sequentially runs each instance of the program in a loop. Each instance of the program reads the input data chunks from the space layer 120 and processes the data. The processing results are saved in the space layer 120 (S380). The single-core mode can serve as a simulation mode for debugging purposes. This allows developers to use a regular debugger to debug their parallel processing programs under the single-core mode instead of migrating the application to other modes.

At S350, to handle processing in a cluster mode, the parallel processing program is replicated to different computers in the cluster. This may be achieved using, for example, a message passing interface (MPI) in which the memory space of the program is automatically replicated to the other computers when the program gets initialized. Thereafter, at S355, the job scheduler causes each computer to process a single instance of the program. At S380, the processing results, from all computers, are written to the space layer 120 in which the job scheduler is located.

In a multi-thread mode, a pool of threads is created (S360). In addition, instances of the parallel processing program are instantiated. Then, at S365, each thread executes a single instance of the program. The instances of the program are executed in parallel and share the same memory address space. The processing results of all threads are written to the space layer 120 (S380).

In order to develop a parallel processing program that can be efficiently executed on the computing system 100, a developer should use one of the basic design patterns provided with kernel layer 130. The parallel processing program's code should inherit from a selected basic design pattern. The selection of the pattern may be from a library provided as part of the developing tool. To debug the application the mode of the computing system 100 should be set to a single-core mode. This allows debugging the application using a regular debugger, such as gdb or Visual C++ debugger. To test the program the mode of operation should be re-configured to either a multi-thread-mode or a cluster-mode. Parallel processing programs or applications developed using this paradigm allows users to easily deploy their applications on different environments, either cluster-based hardware infrastructures or workstations with multiple cores.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

Most preferably, the principles of the invention, and in particular, the configurable computing system 100 and the job scheduler can be implemented in hardware, firmware, software, or any combination thereof. Moreover, the software is preferably implemented as an application program tangibly embodied on a program storage unit or computer readable medium. One of ordinary skill in the art would recognize that a “machine readable medium” is a medium capable of storing data and can be in a form of a digital circuit, an analogy circuit or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

1. A configurable computing system for parallel processing of software applications, comprising:
an environment abstraction layer (EAL) for abstracting low-level functions to the software applications;
a space layer including a distributed data structure; and
a kernel layer including a job scheduler for executing parallel processing programs constructing the software applications according to a configurable mode.

2. The computing system of claim 1, wherein the computing system executes over a hardware layer of a high-performance computing (HPC) platform.

3. The computing system of claim 2, wherein the HPC platform comprises any of multi-core computers connected in a network, single-core computers connected in a network, and a computer cluster.

4. The computing system of claim 1, wherein low level functions comprise at least hardware functions and operating system functions.

5. The computing system of claim 1, wherein the kernel layer further comprises parallelization design patterns that can be inherited by the parallel processing programs.

6. The computing system of claim 5, wherein parallelization design patterns are structured in an inheritance tree, wherein a root of the inheritance tree is kernel-base program.

7. The computing system of claim 1, wherein the configurable mode of operation comprises any of a single-core mode, a multi-thread mode, and a cluster mode.

8. The computing system of claim 7, wherein executing a parallel processing program comprises:
reading a configuration file designating the configurable mode of operation;
saving input data in the space layer;
running instances of the parallel processing program according to the configurable mode of operation; and
saving output data generated by instances in the space layer.

9. The computing system of claim 8, wherein the configurable mode is the single-core mode, the step of running instances of the parallel processing program comprises:
creating a predefined number of instances of the parallel processing program; and
sequentially running each instance of in a loop.

10. The computing system of claim 8, wherein the configurable mode is the cluster mode, the step of running instances of the parallel processing program comprises:
replicating the parallel processing program to different computers in a computer cluster; and
processing independently a single parallel processing program on the different computers in the computer cluster.

11. The computing system of claim 8, wherein the configurable mode is the multi-thread mode, the step of running instances of the parallel processing program comprises:
creating a pool of threads;
creating instances of the parallel processing program; and
executing a single instance in a single thread.

12. The computing system of claim 11, wherein instances are executed in parallel and share the same memory space.

13. A method for executing a software application including at least one parallel processing program over a high-performance computing (HPC) platform, comprising:
reading a configuration file designating a configurable mode of operation of the HPC platform;
saving input data required for executing the parallel processing program in a space layer;
running instances of the parallel processing program according to the configurable mode of operation; and
saving output data generated by instances in the space layer.

14. The method of claim 13, comprising the step of executing the software application over at least one of: multi-core computers connected in a network; single-core computers connected in a network; and a computer cluster.

15. The method of claim 13, comprising the step of:
distributing a data structure in the space layer; and
accessing the data by any computer in the HPC platform.

16. The method of claim 13, wherein the configurable mode of operation is any of: a single-core mode, a multi-thread mode, and a cluster mode.

17. The method of 16, wherein the configurable mode of operation is the single-core mode, the step of running instances of the parallel processing program comprises:
creating a predefined number of instances of the parallel processing program; and
sequentially running each instance in a loop.

18. The method of claim 16, wherein the configurable mode is the cluster mode, the step of running instances of the parallel processing program comprises:
replicating the parallel processing program to different computers in a computer cluster; and
processing independently a single parallel processing program on a computer in the computer cluster.

19. The method of claim 16, wherein the configurable mode is the multi-thread mode, the step of running instances of the parallel processing program comprises:
creating a pool of threads;
creating instances of the parallel processing program; and
executing a single instance in a single thread.

20. The method of claim 19, wherein the instances are executed in parallel and share the same memory address.

21. A computer readable medium having stored thereon instructions which, when executed by a computer, perform a method for executing a software application including at least one parallel processing program over a high-performance computing (HPC) platform, the method comprising:
reading a configuration file designating a configurable mode of operation of the HPC platform;
saving input data required for executing the parallel processing program in a space layer;
running instances of the parallel processing program according to the configurable mode of operation; and
saving output data generated by instances in the space layer.
